(19) United States
(12) Patent Application Publication
(10) Pub. No.: US 2020/0313166 A1
(43) Pub. Date: Oct. 1, 2020

(54) ELECTROCHEMICAL DEVICE

(71) Applicant: TAIYO YUDEN CO., LTD., Tokyo (JP)

(72) Inventor: Yuki KAWAI, Takasaki-shi (JP)

(21) Appl. No.: 16/818,856

(22) Filed: Mar. 13, 2020

(30) Foreign Application Priority Data
Mar. 27, 2019 (JP) 2019-060149

(51) Int. Cl. H01M 4/134; H01M 4/62; H01M 4/04; H01M 10/052; H01M 10/0587; H01M 2/16; H01G 11/06

(52) U.S. Cl. CPC H01M 4/134; H01M 4/621; H01M 4/0404; H01M 2004/027; H01M 10/0587; H01M 2/1673; H01G 11/06; H01M 10/052

(57) ABSTRACT

An electrochemical device includes: a positive electrode, a negative electrode, a separator, and an electrolyte solution, wherein the negative electrode includes: a first main surface on which a first negative-electrode active material layer is formed, and a second main surface including a coating region in which a second negative-electrode active material layer is formed, a non-coating region in which the second negative-electrode active material layer is not formed, and a plurality of through-holes for allowing the first main surface to communicate with the second main surface, wherein the second negative-electrode active material layer includes a first portion having a first thickness and a second portion being located between the first portion and the non-coating region and having a second thickness smaller than the first thickness, the non-coating region being electrically connected to metal lithium.

### BACKGROUND ART

The present disclosure relates to an electrochemical device that uses lithium ions as an electric charge carrier.

In an electrochemical device that uses lithium ions of a lithium-ion capacitor or the like as an electric charge carrier, a negative electrode is doped (pre-doped) with lithium ions during manufacture. A positive electrode and negative electrode are alternately laminated with a separator interposed therebetween. A lithium source of metal lithium or the like is electrically connected to the negative electrode. Lithium ions discharged from the lithium source move in an electrolyte solution, and the negative electrode is doped with the lithium ions.

The negative electrode includes an active material layer laminated on an current collector, which is a metal foil, and surfaces of the current collector. Multiple through-holes are formed in the current collector in order to allow lithium ions to pass the current collector. Here, in a case where the formation of the through-holes deteriorates the strength of the current collector, there is a problem that the electrode is bent when force is applied on the electrode.

In particular, in a case where a coating region in which the active material layer is laminated and a non-coating region in which the active material layer is not laminated exist on the current collector, the boundary between the coating region and the non-coating region is easily bent. While the current collector is conveyed for coating or winding, the current collector can be thus bent, which lowers the yield. Japanese Patent Application Laid-open No. 2008-243658 and Japanese Patent Application Laid-open No. 2009-164061 (hereinafter, referred to as Patent Literatures 1 and 2, respectively) have each disclosed a non-aqueous secondary battery associated with control of the coating region and the non-coating region.

### SUMMARY OF THE INVENTION

Regarding the electrochemical device that uses lithium ions as the electric charge carrier, the negative electrode needs to be uniformly doped with lithium ions. If lithium ions concentrate on a part of the negative electrode, it takes long time until lithium ions are finally uniformly distributed.

Since the configurations as described in Patent Literature 1 and 2 above are to prevent falling of the active material layer and bending of the electrode when the active material layer is partially thicker, there is a possibility that lithium ions may concentrate.

In view of the above-mentioned circumstances, it is desirable to provide an electrochemical device by which uniform pre-doping with lithium ions can be achieved while preventing bending of the electrode.

Additional or separate features and advantages of the disclosure will be set forth in the descriptions that follow and in part will be apparent from the description, or may be learned by practice of the disclosure. The objectives and other advantages of the disclosure will be realized and attained by the structure particularly pointed out in the written description and claims thereof as well as the appended drawings.

To achieve these and other advantages and in accordance with the purpose of the present disclosure, as embodied and broadly described, in one aspect, the present disclosure provides an electrochemical device according to an embodiment of the present disclosure includes a positive electrode, a negative electrode, a separator, and an electrolyte solution.

The positive electrode includes a positive electrode including a positive-electrode current collector including a conductive material and a positive-electrode active material layer formed on the positive-electrode current collector.

The negative electrode includes a first negative-electrode active material layer and a second negative-electrode active material layer and a negative-electrode current collector including a first main surface on which the first negative-electrode active material layer is formed, a second main surface including a coating region in which the second negative-electrode active material layer is formed, a non-coating region in which the second negative-electrode active material layer is not formed, and a plurality of through-holes for allowing the first main surface to communicate with the second main surface, the second negative-electrode active material layer including a first portion having a first thickness and a second portion being located between the first portion and the non-coating region and having a second thickness smaller than the first thickness, the non-coating region being electrically connected to metal lithium.

The separator insulates the positive electrode from the negative electrode.

In the electrolyte solution, the positive electrode, the negative electrode, and the separator are immersed.

The non-coating region is electrically connected to metal lithium. Immersed in the electrolyte solution, the first negative-electrode active material layer and the second negative-electrode active material layer are pre-doped with lithium ions.

In accordance with this configuration, the second portion having a smaller thickness is provided between the first portion and non-coating region. Therefore, the negative electrode is prevented from being bent at the boundary between the second negative-electrode active material layer and the non-coating region. Further, concentration of lithium ions on the boundary portion between the second negative-electrode active material layer and the non-coating region is prevented at the time of pre-doping with lithium ions and lithium ions can be uniformly distributed on the second negative-electrode active material layer.

The third thickness may be the sum of a thickness of the second portion, a thickness of the negative-electrode current collector, and a thickness of the first negative-electrode active material layer is 80% or more and 95% or less of a fourth thickness that is the sum of a thickness of the first portion, a thickness of the negative-electrode current collector, and a thickness of the first negative-electrode active material layer.

The first negative-electrode active material layer and the second negative-electrode active material layer may include a material obtained by mixing a negative-electrode active material, a conductive assistant, and a binder resin.

The positive electrode and the negative electrode may be laminated with the separator interposed between the positive electrode and the negative electrode and are wound.

The electrochemical device may be a lithium-ion capacitor.

As described above, in accordance with the present disclosure, it is possible to provide a manufacturing method for an electrochemical device and an electrochemical device by which the electrode can be prevented from being deviated and uniform doping with lithium ions can be achieved.

These and other objects, features and advantages of the present disclosure will become more apparent in light of the following detailed description of embodiments thereof, as illustrated in the accompanying drawings.

It is to be understood that both the foregoing general description and the following detailed description are exemplary and explanatory, and are intended to provide further explanation of the disclosure as claimed.

### BRIEF DESCRIPTION OF THE DRAWINGS

FIG. 1 is a perspective view of an electrochemical device according to an embodiment of the present disclosure;

FIG. 2 is a perspective view of a power storage element of the electrochemical device;

FIG. 3 is a cross-sectional view of a part of the power storage element of the electrochemical device;

FIGS. 4A and 4B are plan views of a negative electrode of the power storage element of the electrochemical device;

FIGS. 5A and 5B are plan views of a negative electrode of the power storage element of the electrochemical device;

FIG. 6 is a cross-sectional view of the power storage element of the electrochemical device;

FIGS. 7A and 7B are schematic views showing a negative-electrode thickness of the power storage element of the electrochemical device;

FIG. 8 is a schematic view showing a negative-electrode thickness of a power storage element of an electrochemical device according to a comparative example; and

FIG. 9 is a table showing comparison results of an example according to the present disclosure and a comparative example.

### DETAILED DESCRIPTION OF THE EMBODIMENTS

An electrochemical device according to an embodiment of the present disclosure will be described. The electrochemical device according to this embodiment is an electrochemical device that uses lithium ions for transportation of electric charges for a lithium-ion capacitor or the like. It should be noted that in the following figures, X, Y, and Z directions are three directions orthogonal to one another.

### Configuration of Electrochemical Device

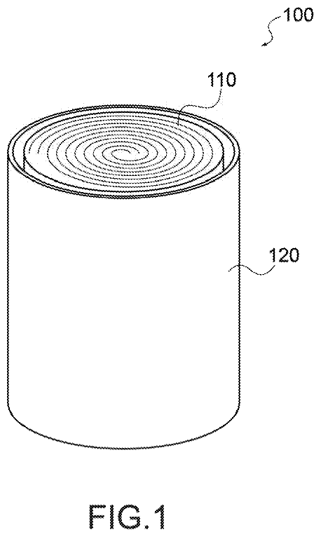

FIG. 1 is a perspective view showing a configuration of an electrochemical device 100 according to this embodiment. Regarding the electrochemical device 100 as shown in the figure, a power storage element 110 is housed in a container 120 (the lid and the terminal are not shown the figure). The power storage element 110 is housed with an electrolyte solution in the container 120. It should be noted that the configuration of the electrochemical device 100 according to this embodiment is not limited to the configuration shown in FIG. 1 and the subsequent figures.

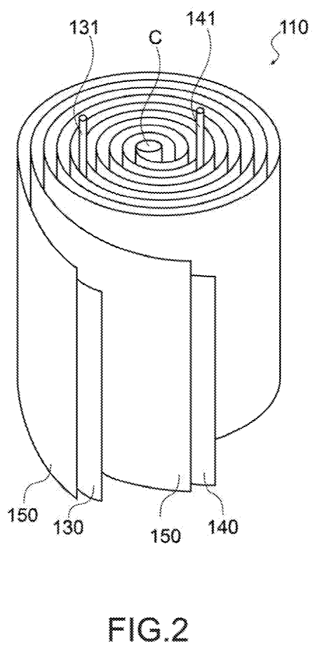

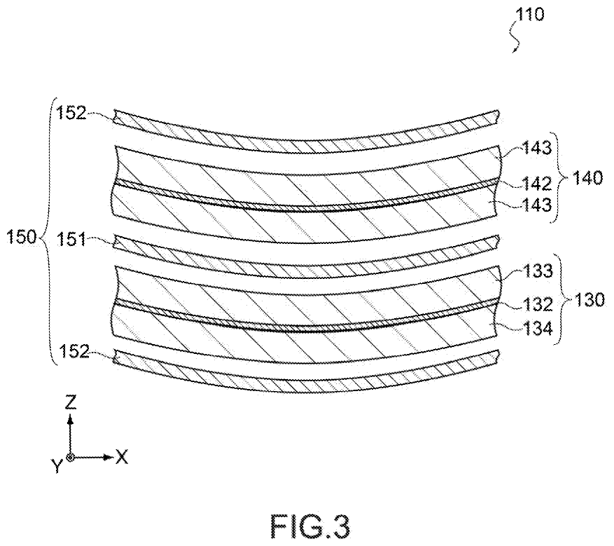

FIG. 2 is a perspective view of the power storage element 110. FIG. 3 is an enlarged cross-sectional view of the power storage element 110. As shown in FIGS. 2 and 3, the power storage element 110 includes a negative electrode 130, a positive electrode 140, and separators 150. A laminate of the negative electrode 130, the positive electrode 140, and the separators 150 is wound around a winding core C. Note that the winding core C is not necessarily essential.

The order of lamination of the negative electrode 130, the positive electrode 140, and the separators 150 that constitute the power storage element 110 is the order of the separator 150, the negative electrode 130, the separator 150, and the positive electrode 140 toward the winding core C (from outside of winding) as shown in FIG. 2. The power storage element 110 further includes a negative electrode terminal 131 and a positive electrode terminal 141 as shown in FIG. 2. The negative electrode terminal 131 is connected to the negative electrode 130 and the positive electrode terminal 141 is connected to the positive electrode 140. As shown in FIG. 2, the negative electrode terminal 131 and the positive electrode terminal 141 are each pulled out of the power storage element 110.

As shown in FIG. 3, the negative electrode 130 includes a negative-electrode current collector 132, a first negative-electrode active material layer 133, and a second negative-electrode active material layer 134. The negative-electrode current collector 132 is made of a conductive material. A metal foil such as a copper foil can be used as the negative-electrode current collector 132. In this embodiment, a metal foil having a number of through-holes is employed as the negative-electrode current collector 132.

The first negative-electrode active material layer 133 and the second negative-electrode active material layer 134 are formed on the negative-electrode current collector 132. The material of the first negative-electrode active material layer 133 and the second negative-electrode active material layer 134 can be a mixture of a negative-electrode active material and a binder resin. The mixture may further include a conductive assistant. The negative-electrode active material is a material which can be doped with lithium ions in the electrolyte solution. Examples of the negative-electrode active material can include a carbon-based material such as non-graphitizable carbon (hard carbon), graphite, soft carbon, an alloy-based material such as Si and SiO, and a composite material thereof can be used.

The binder resin is a synthetic resin for bonding the negative-electrode active material. Examples of the binder resin can include styrene-butadiene rubber, polyethylene, polypropylene, aromatic polyamide, carboxymethyl cellulose, fluorine-based rubber, polyvinylidene fluoride, isoprene rubber, butadiene rubber, and ethylene-propylene-based rubber.

The conductive assistant is particles of the conductive material and enhances the conductivity with the negative-electrode active material. Examples of the conductive assistant can include a carbon material such as graphite and carbon black. Only one of them may be used or a plurality of them may be used. Note that in a case where the conductive assistant is made of the conductive material, a metal material, conductive polymer, or the like may be used.

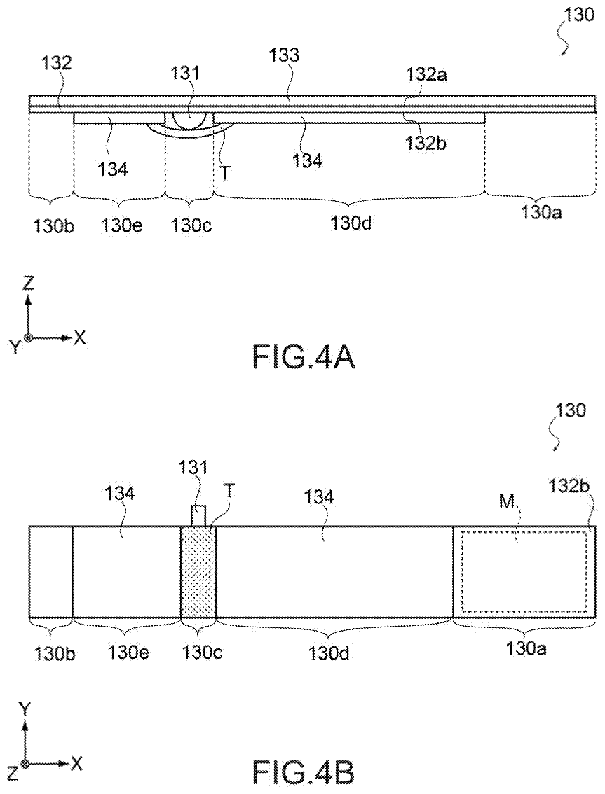

FIGS. 4A and 4B are schematic views showing the negative electrode 130 before winding. FIG. 4A is a side view and FIG. 4B is a plan view. In the negative electrode 130 according to this embodiment, the first negative-electrode active material layer 133 is formed on a first main surface 132a of the negative-electrode current collector 132 and the second negative-electrode active material layer 134 is formed on a second main surface 132b of the negative-electrode current collector 132 as shown in FIG. 4A.

The first negative-electrode active material layer 133 is formed on the entire first main surface 132a. On the other hand, the second negative-electrode active material layer 134 is discontinuously formed on the second main surface 132b. As shown in FIG. 4A, a first non-coating region 130a, a second non-coating region 130b, and a third non-coating region 130c in which the second negative-electrode active material layer 134 is not formed are provided on the second main surface 132b, and a first coating region 130d and a second coating region 130e in which the second negative-electrode active material layer 134 is formed are provided.

End portions of the first coating region 130d and the second coating region 130e are provided with portions in which the thickness of the second negative-electrode active material layer 134 is different. It will be described later in detail.

As shown in FIG. 4B, metal lithium M, which is a lithium ions supply source, is bonded to the negative-electrode current collector 132 within the first non-coating region 130a, such that the metal lithium M is electrically connected to the negative-electrode current collector 132. Although the shape of the metal lithium M is not particularly limited, it is favorable that the metal lithium M has a foil shape for reducing the thickness of the power storage element 110. The amount of metal lithium M can be set such that the first negative-electrode active material layer 133 and the second negative-electrode active material layer 134 can be doped with the metal lithium M in pre-doping with lithium ions to be described later.

Although the length of the first non-coating region 130a and the second non-coating region 130b in the X direction is not particularly limited, it is favorable that the length of the second non-coating region 130b in the X direction is about ½π times as large as the diameter of the winding core C. The second non-coating region 130b does not need to be provided.

As shown in FIG. 4A, the negative electrode terminal 131 is connected to the negative-electrode current collector 132 within the third non-coating region 130c and is pulled out of the negative electrode 130. The third non-coating region 130c is sealed with a tape T as shown in FIG. 4A to prevent the negative-electrode current collector 132 within the third non-coating region 130c from being exposed. Although the type of the tape T is not particularly limited, one having heat-resistance and solvent resistance to a solvent of the electrolyte solution is favorably employed. The negative electrode terminal 131 is a copper terminal, for example. Note that the tape T may be omitted if unnecessary.

As shown in FIG. 3, the positive electrode 140 includes a positive-electrode current collector 142 and positive-electrode active material layers 143. The positive-electrode current collector 142 is made of a conductive material. A metal foil such as an aluminum foil can be used for the positive-electrode current collector 142. The positive-electrode current collector 142 may be a metal foil whose surface are chemically or mechanically roughened or may be a metal foil with through-holes.

The positive-electrode active material layers 143 are formed on front and back surfaces of the positive-electrode current collector 142. The material of the positive-electrode active material layers 143 can be each a mixture of a positive-electrode active material and a binder resin and may further include a conductive assistant. The positive-electrode active material is a material to which lithium ions and anions in the electrolyte solution can stick. Activated carbon, polyacene carbide, or the like may be used for the positive-electrode active material.

The binder resin is a synthetic resin for bonding the positive-electrode active material. Examples of the binder resin can include styrene-butadiene rubber, polyethylene, polypropylene, aromatic polyamide, carboxymethyl cellulose, fluorine-based rubber, polyvinylidene fluoride, isoprene rubber, butadiene rubber, and ethylene-propylene-based rubber.

The conductive assistant is particles of the conductive material and enhances the conductivity with the positive-electrode active material. Examples of the conductive assistant can include a carbon material such as graphite and carbon black. Only one of them may be used or a plurality of them may be used. Note that in a case where the conductive assistant is made of the conductive material, a metal material, conductive polymer, or the like may be used.

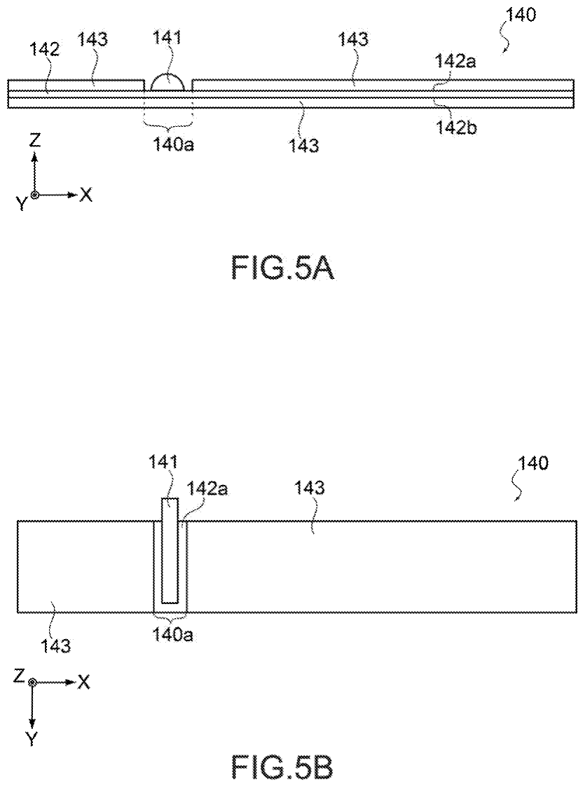

FIGS. 5A and 5B are schematic views showing the positive electrode 140 before winding. FIG. 5A is a side view and FIG. 5B is a plan view. As shown in FIG. 5A, in the positive electrode 140, the positive-electrode active material layers 143 are formed on the both surfaces that are a third main surface 142a and a fourth main surface 142b of the positive-electrode current collector 142. Further, a non-coating region 140a in which the positive-electrode active material layers 143 are not formed in the third main surface 142a is provided.

Here, the positive electrode terminal 141 is connected to the positive-electrode current collector 142 within the non-coating region 140a and is pulled out of the positive electrode 140 as shown in FIGS. 5A and 5B. Note that in the positive electrode 140, the non-coating region 140a in which the positive electrode terminal 141 is disposed may be formed on the fourth main surface 142b. Further, the non-coating region 140a may be sealed with a tape or the like. The positive electrode terminal 141 is an aluminum terminal, for example.

The separators 150 insulate the negative electrode 130 from the positive electrode 140 and include a first separator 151 and the second separators 152 as shown in FIG. 3.

The first separator 151 and the second separators 152 isolate the negative electrode 130 from the positive electrode 140 and allow ions contained in the electrolyte solution to be described later pass through the first separator 151 and the second separators 152. Specifically, the first separator 151 and the second separators 152 can be each woven fabric, non-woven fabric, a synthetic resin microporous film, or the like. For example, one having an olefinic resin as a main material may be employed for the first separator 151 and the second separators 152. Further, the first separator 151 and the second separators 152 may be a single continuous separator.

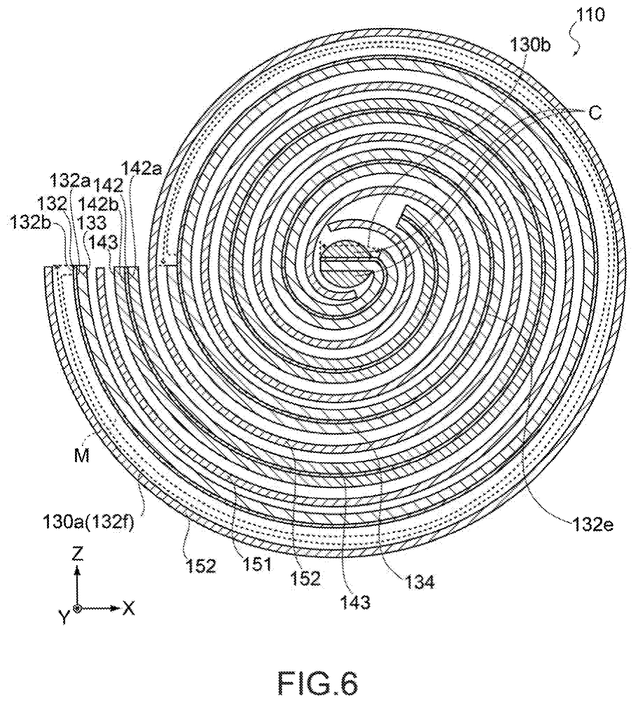

FIG. 6 is a cross-sectional view of the power storage element 110 (the negative electrode terminal 131 and the positive electrode terminal 141 are not shown the figure). As shown in FIG. 6, in the power storage element 110 according to this embodiment, the negative electrode 130 and the positive electrode 140 are laminated with the first separator 151 and the second separators 152 interposed therebetween and are wound. Specifically, when they are wound, the first main surface 132a of the negative-electrode current collector 132 and the third main surface 142a of the positive-electrode current collector 142 are arranged inside and the second main surface 132b of the negative-electrode current collector 132 and the fourth main surface 142b of the positive-electrode current collector 142 are arranged outside.

Here, the outermost (radially outermost) electrode of the wound body is the negative electrode 130.

As shown in FIG. 6, the first non-coating region 130a is provided in the second main surface 132b of the negative-electrode current collector 132 on the outermost side of the wound body and the second non-coating region 130b is provided at the end portion of the negative-electrode current collector 132 on the innermost side of the wound body.

Further, as shown in FIG. 6, the first main surface 132a of the negative-electrode current collector 132 faces the positive electrode 140 (the positive-electrode active material layers 143) with the first separator 151 interposed therebetween. As shown in the figure, the second main surface 132b includes a first region 132e that faces the positive electrode 140 (the positive-electrode active material layers 143) with the second separators 152 interposed therebetween and a second region 132f that does not face the positive electrode 140 (the positive-electrode active material layers 143) with the second separators 152 interposed therebetween on the outermost side of the wound body. The power storage element 110 according to this embodiment is electrically connected with the metal lithium M bonded to this second region 132f

The container 120 houses the power storage element 110. The upper surface and the lower surface of the container 120 can be closed by the lid (not shown). The material of the container 120 is not particularly limited and may include, for example, metal and stainless having aluminum, titanium, nickel, or iron as a main component.

The power storage element 110 is housed in the container 120 with the electrolyte solution. Although the electrolyte solution is not particularly limited, a solution having LiPF6 or the like as a solute may be used.

### Regarding Thickness of Negative-Electrode Active Material Layer

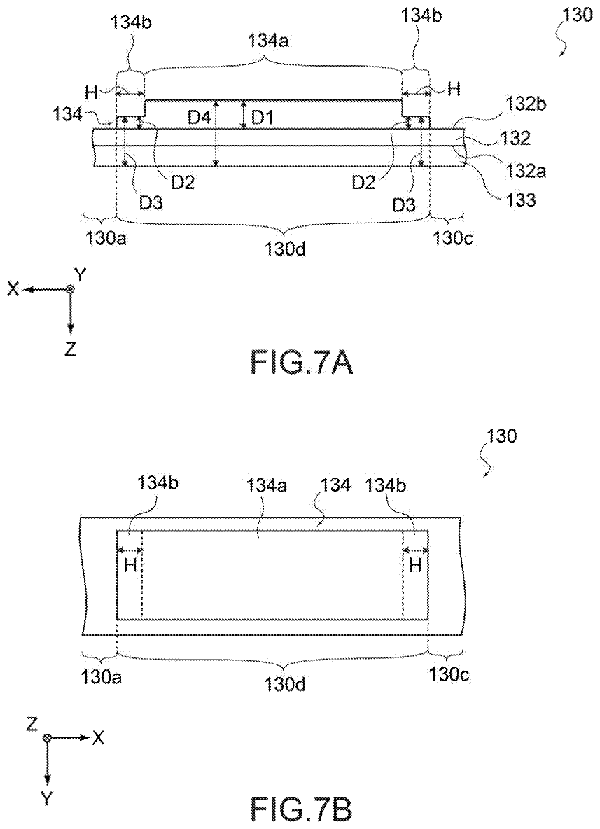

The thickness of the second negative-electrode active material layer 134 will be described. FIGS. 7A and 7B are schematic views showing the negative electrode 130. FIG. 7A is a side view and FIG. 7B is a plan view.

Although the negative electrode 130 has the first coating region 130d and the second coating region 130e as shown in FIGS. 4A and 4B, the first coating region 130d will be described here.

As shown in FIGS. 7A and 7B, the second negative-electrode active material layer 134 includes a first portion 134a and second portions 134b.

The first portion 134a occupies a most part of the first coating region 130d. The second portions 134b are portions between the first portion 134a and the non-coating regions (the first non-coating region 130a and the third non-coating region 130c).

The first portion 134a is a portion in which the second negative-electrode active material layer 134 has a predetermined thickness D1. The second portions 134b are portions in which the second negative-electrode active material layer 134 has a thickness D2 smaller than that of the first portion 134a.

The sum of the thickness of the second portions 134b, the thickness of the negative-electrode current collector 132, and the thickness of the first negative-electrode active material layer 133 is set to a thickness D3. Further, the sum of the thickness of the first portion 134a, the thickness of the negative-electrode current collector 132, and the thickness of the second negative-electrode active material layer 134 is set to a thickness D4.

It is favorable that the thickness D3 is 80% or more and 95% or less of the thickness D4. Further, it is favorable that a width H of the second portions 134b in a longitudinal direction (X direction) of the negative electrode 130 is about 5 mm.

Note that although the first coating region 130d has been described here, the first portion 134a and the second portions 134b are provided also in the second coating region 130e, and the second portions 134b are portions between the first portion 134a and the non-coating regions (the second non-coating region 130b and the third non-coating region 130c).

### Regarding Effect of Second Portion

As described above, the second negative-electrode active material layer 134 includes the second portions 134b which are portions between the first portion 134a and the non-coating regions. An effect due to the provision of the second portions 134b will be described in comparison with a comparative example.

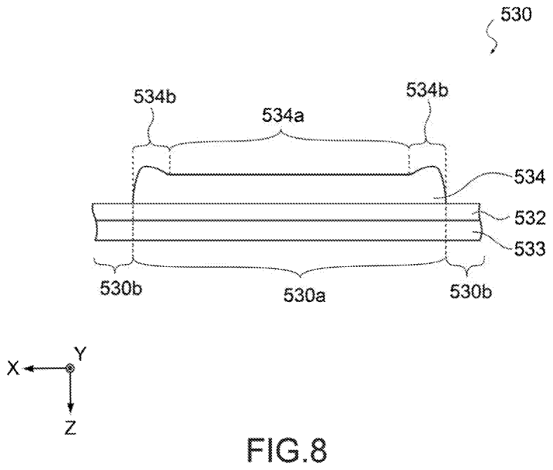

FIG. 8 is a schematic view of a negative electrode 530 according to the comparative example. As shown in the figure, the negative electrode 530 includes a negative-electrode current collector 532, a first negative-electrode active material layer 533, and a second negative-electrode active material layer 534. The second negative-electrode active material layer 534 is formed by discontinuous application on the negative-electrode current collector 532, and a coating region 530a and non-coating regions 530b are provided.

Here, the second negative-electrode active material layer 534 includes a first portion 534a and second portions 534b as shown in FIG. 8. The second portions 534b are portions between the first portion 534a and the non-coating regions 530b. The second portions 534b are thicker than the first portion 534a.

For laminating the second negative-electrode active material layer 534 on the negative-electrode current collector 532, a negative-electrode paste obtained by mixing a negative-electrode active material, a binder resin, and a conductive assistant is discharged onto the negative-electrode current collector 532 from the die. For performing discontinuous application, it is necessary to temporarily stop discharging the negative-electrode paste at the end portion of the coating region 530a. At this time, the negative-electrode paste swells, and the second portions 534b are formed as shown in FIG. 8.

Therefore, when force is applied to the negative electrode 530, the negative electrode 530 is bent at the boundaries between the second portions 534b and the non-coating regions 530b, which deteriorates the yield in winding the device.

In addition, the thicker second portions 534b are doped with a greater amount of lithium ions in pre-doping, and lithium ions are not uniformly distributed. Accordingly, it takes long time until lithium ions are finally uniformly distributed.

In contrast, with the negative electrode 130 according to this embodiment, the second portions 134b in which the thickness of the second negative-electrode active material layer 134 is smaller is provided between the first portion 134a and the non-coating regions, and the negative electrode 130 is less likely to be bent at the boundaries between the second negative-electrode active material layer 134 and the non-coating regions. Further, lithium ions are prevented from concentrating on the second portions 134b and lithium ions are uniformly distributed in pre-doping.

### Manufacturing Method for Electrochemical Device

A manufacturing method for the electrochemical device 100 according to this embodiment will be described. Note that the manufacturing method shown below is an example, and the electrochemical device 100 can also be manufactured in accordance with a manufacturing method different from the manufacturing method shown below.

The negative electrode 130 can be fabricated by applying a negative-electrode paste including a negative-electrode active material, a conductive assistant, a binder, and the like to the first main surface 132a of the negative-electrode current collector 132 and the second main surface 132b and drying or curing it. The application of the negative-electrode paste is performed by moving the negative-electrode current collector 132 in the longitudinal direction (X direction) while discharging the negative-electrode paste from the die. The die having a flat end is used.

When a valve for supplying the die with the negative-electrode paste is opened, a coating region is formed. When the valve is closed, a non-coating region is formed. In the second negative-electrode active material layer 134, the valve is opened and the first portion 134a is formed. Then, the valve is closed at a distance of about 5 mm (about 10 μs as time) from the front of the non-coating region. In this manner, the second portion 134b can be formed.

Subsequently, the negative electrode 130 can be fabricated by cutting the negative-electrode current collector 132, the first negative-electrode active material layer 133, and the second negative-electrode active material layer 134, connecting the negative electrode terminal 131 to the third non-coating region 130c, and sealing it with the tape T.

The positive electrode 140 can be fabricated by applying a positive electrode paste including a positive-electrode active material, a conductive assistant, a binder, and the like to the third main surface 142a and the fourth main surface 142b of the positive-electrode current collector 142 and drying or curing it. The application of the positive-electrode paste is performed by discharging the positive-electrode paste from the die while moving the positive-electrode current collector 142 in the longitudinal direction (X direction).

Subsequently, the positive electrode 140 can be fabricated by cutting the positive-electrode current collector 142 and the positive-electrode active material layers 143 and connecting the positive electrode terminal 141 to the non-coating region 140a.

Subsequently, the negative electrode 130, the positive electrode 140, the first separator 151, and the second separators 152 are laminated and wound as shown in FIG. 6. At this time, the negative electrode 130 is located on the outer side of the wound body and the positive electrode 140 is located on the inner side of the wound body. The second non-coating region 130b of the negative electrode 130 is located on the side of the winding core C.

Subsequently, the power storage element 110 is obtained by electrically connecting the metal lithium M to the first non-coating region 130a located on the outermost side of the wound body resulting from the above-mentioned steps (see FIG. 6). Then, the power storage element 110 to which the metal lithium M has been electrically connected is housed in the container 120 filled with the electrolyte solution and the container 120 is sealed. The negative electrode 130 is thus pre-doped with lithium ions from the metal lithium M. The electrochemical device 100 can be manufactured in the above-mentioned manner.

Although the embodiment of the present disclosure has been described above, the present disclosure is not limited to that embodiment and various modifications can be made as a matter of course.

In the above-mentioned embodiment, the winding-type lithium-ion capacitor has been shown as an example of the electrochemical device 100. For example, the present disclosure can also be applied to a lamination-type lithium-ion capacitor or lithium-ion battery obtained by alternately laminating sheet-shaped positive electrodes and sheet-shaped negative electrodes on one another with separators interposed therebetween.

### EXAMPLE

An electrochemical device (40F 1235) having the structure of the electrochemical device 100 according to the embodiment was used as an electrochemical device according to an example.

Further, an electrochemical device (40F 1235) including the negative electrode 530 in place of the negative electrode 130 of the electrochemical device 100 was used as an electrochemical device according to a comparative example.

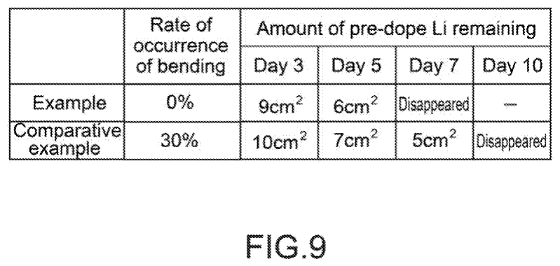

Regarding the electrochemical devices according to the example and the comparative example, bending of the negative electrode at the time of winding was compared to the amount of metal lithium not dissolved at the time of pre-doping. FIG. 9 is a table showing results of comparison.

As shown in the figure, bending of the negative electrode 530 occurred in the electrochemical device at 30% at the time of winding in the comparative example. On the other hand, bending of the negative electrode 130 did not occur at the time of winding in the example.

Further, FIG. 9 show lapsed day(s) and the area of remaining metal lithium after the start of pre-doping with lithium ions as the amount of metal lithium not dissolved. In the example, the metal lithium disappeared on day 7 after pre-doping. In the comparative example, the metal lithium disappeared on day 10 after pre-doping.

As it can be seen from the results, the negative electrode can be prevented from being bent and the time for pre-doping with lithium ions can be reduced with the electrochemical device according to this embodiment.

It will be apparent to those skilled in the art that various modifications and variations can be made in the present disclosure without departing from the spirit or scope of the disclosure. Thus, it is intended that the present disclosure cover modifications and variations that come within the scope of the appended claims and their equivalents. In particular, it is explicitly contemplated that any part or whole of any two or more of the embodiments and their modifications described above can be combined and regarded within the scope of the present disclosure.

What is claimed is:

1. An electrochemical device, comprising:
a positive electrode including
a positive-electrode current collector including a conductive material and
a positive-electrode active material layer formed on the positive-electrode current collector;
a negative electrode including
a first negative-electrode active material layer and a second negative-electrode active material layer and
a negative-electrode current collector including
a first main surface on which the first negative-electrode active material layer is formed,
a second main surface including
a coating region in which the second negative-electrode active material layer is formed,
a non-coating region in which the second negative-electrode active material layer is not formed, and
a plurality of through-holes for allowing the first main surface to communicate with the second main surface, the second negative-electrode active material layer including a first portion having a first thickness and a second portion being located between the first portion and the non-coating region and having a second thickness smaller than the first thickness, the non-coating region being electrically connected to metal lithium;
a separator that insulates the positive electrode from the negative electrode; and
an electrolyte solution in which the positive electrode, the negative electrode, and the separator are immersed.

2. The electrochemical device according to claim 1, wherein
a third thickness that is the sum of a thickness of the second portion, a thickness of the negative-electrode current collector, and a thickness of the first negative-electrode active material layer is 80% or more and 95% or less of a fourth thickness that is the sum of a thickness of the first portion, a thickness of the negative-electrode current collector, and a thickness of the first negative-electrode active material layer.

3. The electrochemical device according to claim 1, wherein
the first negative-electrode active material layer and the second negative-electrode active material layer include a material obtained by mixing a negative-electrode active material, a conductive assistant, and a binder resin.

4. The electrochemical device according to claim 1, wherein
the positive electrode and the negative electrode are laminated with the separator interposed between the positive electrode and the negative electrode and are wound.

5. The electrochemical device according to claim 1, which is a lithium-ion capacitor.
